(19) United States
(12) Patent Application Publication
(10) Pub. No.: US 2021/0116912 A1
(43) Pub. Date: Apr. 22, 2021

(54) Dynamically Controlling Unmanned Aerial Vehicles Using Execution Blocks

(71) Applicant: International Business Machines Corporation, Armonk, NY (US)

(72) Inventors: Dmitri Pikus, Haifa (IL); Nili Guy, Haifa (IL); Maya Barnea, Kiryat Bialik (IL); Gil Sharon, HAIFA (IL); ldan Ben-Harrush, Givat Elah (IL)

(21) Appl. No.: 16/654,034

(22) Filed: Oct. 16, 2019

(51) Int. Cl. G05D 1/00; G05B 13/02; B64C 39/02

(52) U.S. Cl. CPC G05D 1/0088; B64D 47/08; B64C 39/024; G05B 13/0265

(57) ABSTRACT

An example system includes a processor to receive media and an event from a deployed unmanned aerial vehicle (UAV). The processor is to send the media and the event to an artificial intelligence (AI) service and receive smart insights from the AI service. The processor is to dynamically generate an execution block based on the smart insights. The processor is to send the generated execution block to an edge device for generating vehicle specific commands.

### BACKGROUND

The present techniques relate to controlling unmanned aerial vehicles (UAVs). More specifically, the techniques relate to dynamically controlling UAVs.

### SUMMARY

According to an embodiment described herein, a system can include processor t receive media and an event from a deployed unmanned aerial vehicle (UAV). The processor can also further send the media and the event to an artificial intelligence (AI) service and receive smart insights from the AI service. The processor can also dynamically generate an execution block based on the smart insights. The processor can also send the generated execution block to an edge device for generating vehicle specific commands.

According to another embodiment described herein, a method can include receiving, via a processor, media and an event from a deployed unmanned aerial vehicle (UAV). The method can further include sending, via the processor, the media and the event to an artificial intelligence (AI) service and receiving smart insights from the AI service. The method can also further include dynamically generating, via the processor, an execution block based on the smart insights. The method can also include sending, via the processor, the generated execution block to an edge device for generating vehicle specific commands.

According to another embodiment described herein, a computer program product for dynamically controlling unmanned aerial vehicles (UAVs) can include computer-readable storage medium having program code embodied therewith. The computer readable storage medium is not a transitory signal per se. The program code executable by a processor to cause the processor to receive media and an event from a deployed UAV. The program code can also cause the processor to send the media and the event to an artificial intelligence (AI) service and receive smart insights from the AI service. The program code can also cause the processor to dynamically generate an execution block based on the smart insights. The program code can also cause the processor to send the generated execution block to an edge device for generating vehicle specific commands.

### BRIEF DESCRIPTION OF THE SEVERAL VIEWS OF THE DRAWINGS

FIG. 1 is a block diagram of an example system for dynamically controlling UAVs using execution blocks;

FIG. 2 is a block diagram of an example method that can generate execution blocks for dynamically controlling UAVs;

FIG. 3 is a block diagram of an example computing device that can dynamically control UAVs using execution blocks;

FIG. 4 is a process flow diagram of an example cloud computing environment according to embodiments described herein;

FIG. 5 is a process flow diagram of an example abstraction model layers according to embodiments described herein; and

FIG. 6 is an example tangible, non-transitory computer-readable medium that can dynamically control UAVs using execution blocks.

### DETAILED DESCRIPTION

Unmanned aerial vehicles (UAVs), also referred to herein as drones, may be programmed to perform services autonomously. For example, a UAV route and invocation of drone payload may be pre-planned. The payload may include all equipment installed and carried by a deployed drone. The pre-programming may include instructions that determine which data the UAV gathers, which sensors are used to collect the data, and how the data is collected. However, information about real-time environmental conditions may be very limited before the flight of a UAV. Furthermore, a lot of data may be potentially collected during a drone flight from which various insights could potentially be retrieved. Such insight could be used to change various aspects of UAV operation to improve performance. A pre-planned static operation does not allow such insights from real-time environmental conditions to be taken into account when performing services.

According to embodiments of the present disclosure, a computing device can dynamically control UAVs using execution blocks. As used herein, execution blocks are self-contained sequence of commands that can be executed by a deployed UAV without additional information from a server. In some examples, execution blocks may also be executed without additional information from an UAV. An example system includes a processor to receive media and an event from a deployed UAV. The processor is to send the media and the event to an artificial intelligence (AI) service and receive smart insights from the AI service. The processor is to also dynamically generate an execution block based on the smart insights. The processor is to further send the generated execution block to an edge device for generating drone specific commands. Thus, embodiments of the present disclosure allow UAVs to be dynamically controlled in response to particular conditions or detected objects in real-time. In addition, the execution blocks are agnostic to any particular UAV. Thus, the techniques described herein may be used with a variety of different types and specific models of UAVs.

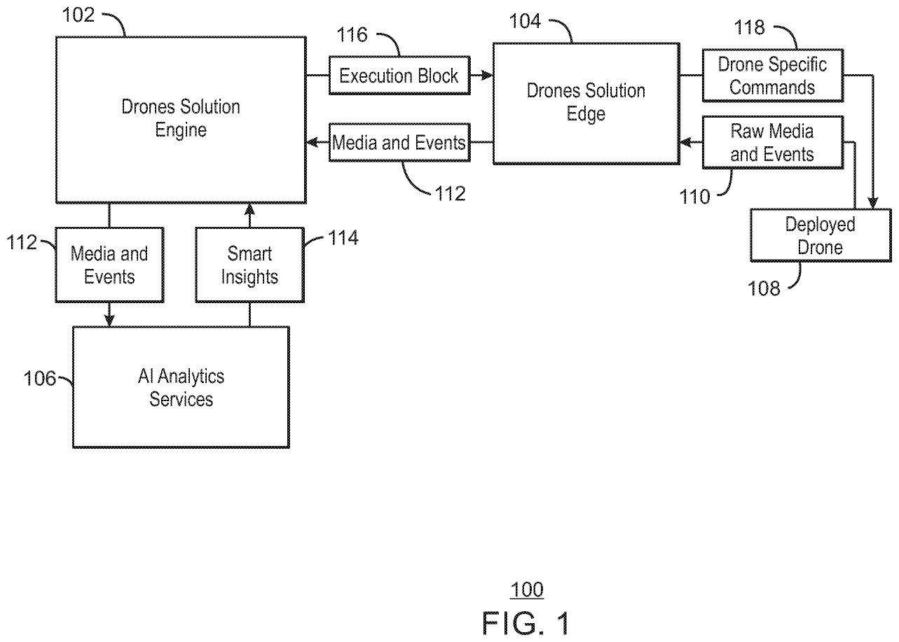

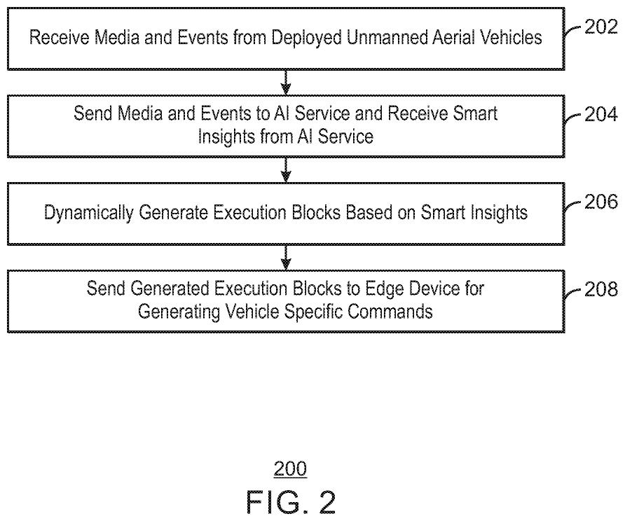

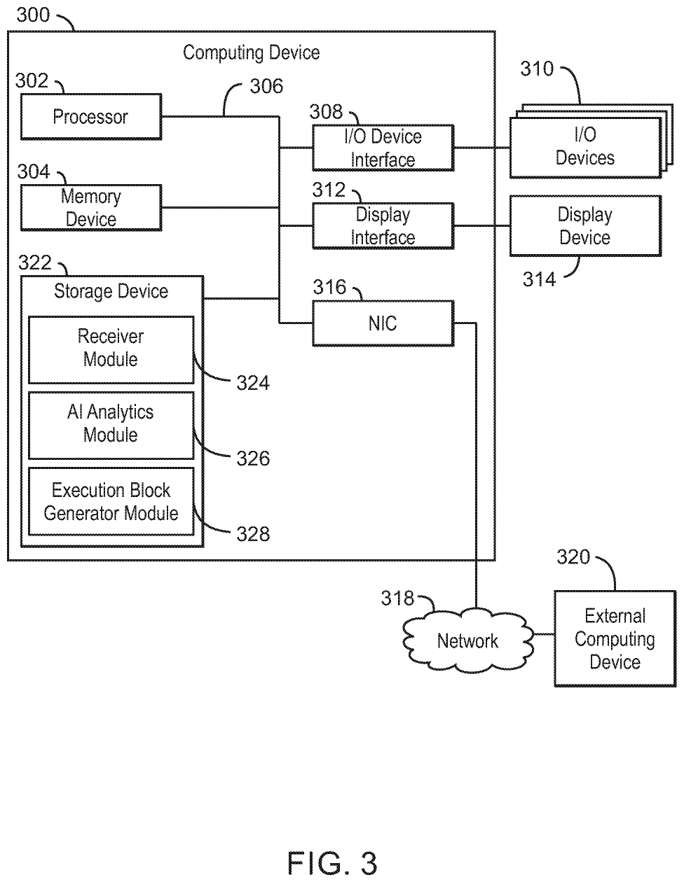

With reference now to FIG. 1, a block diagram shows an example system for dynamically controlling UAVs using execution blocks. The example system 100 can be implemented in the computing device 300 of FIG. 3 using the method 200 of FIG. 2. Although FIG. 1 is described specifically with respect to unmanned aerial vehicles, also referred to herein as drones, the techniques described herein may be used with any UAVs, such as unmanned ground vehicles (UGVs), unmanned surface vehicles (USVs), unmanned underwater vehicles (UUVs), or unmanned spacecraft.

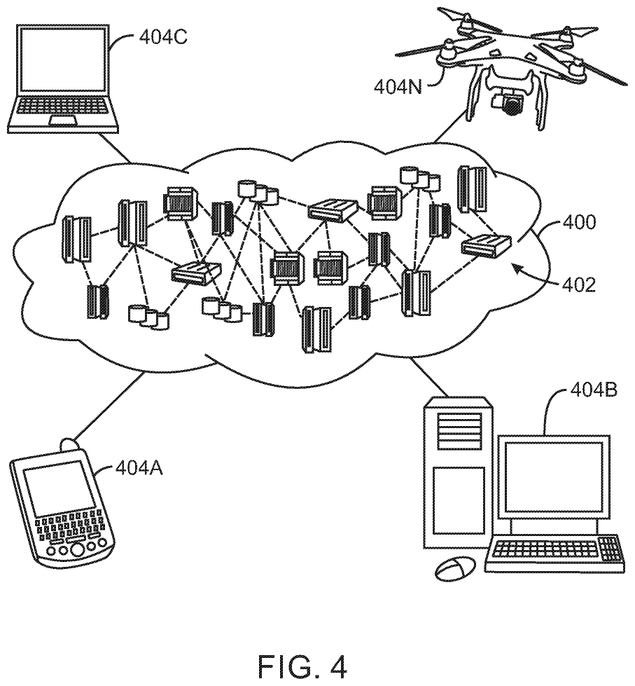

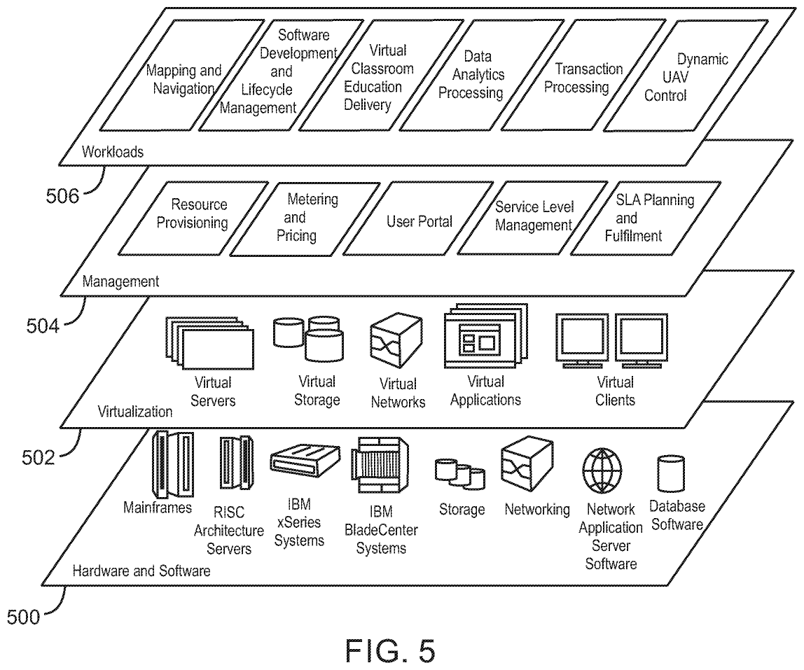

The system 100 of FIG. 1 includes a drones solution engine 102. For example, the drones solution engine 102 may be implemented using a computing device such as a server. The drones solution engine 102 may include server side algorithms, such as a server side state machine, for generating execution blocks. In some examples, the drones solution engine 102 may be implemented in one or more cloud computing nodes as described herein. In various examples, the drones solution engine 102 may be implemented in a server that is located locally on the premises of an organization. The system 100 includes a drones solution edge 104 communicatively coupled to the drones solution engine 102. For example, the drones solution edge 104 may be implemented on another computing device that is a server. In various examples, the drones solution edge 104 may be an edge device that is co-located with the deployed drone 108. In some examples, the drones solution edge 104 may be a mobile device, such as a laptop or a smart phone. For example, the drones solution edge 104 may be a remote controller of the deployed drone 108. In some examples, the drones solution edge 104 may be onboard or a part of the deployed drone 108 itself. The system 100 includes an artificial intelligence (AI) analytics services 106 communicatively coupled to the drones solution engine 102. For example, the AI analytics services 106 may be implemented on a server, such as a cloud node as described in FIGS. 4 and 5. The system 100 further includes a deployed drone 108 communicatively coupled to the drones edge solution 104. For example, the deployed drone 108 may be an unmanned aerial vehicle (UAV) with sensors.

In the example of FIG. 1, a deployed drone 108 can be controlled by a drones solution engine 102 based on real-time raw media and events 110 received from the deployed drone 108. For example, the deployed drone 108 transmits raw media and events 110 to the drones solution edge 104. For example, the raw media and events 110 may include raw media sensor data from the sensors of the deployed drone 108. For example, the deployed drone 108 may include image sensors and may captured images. For example, the captured images may be video. In various examples, the events may include indications that particular conditions are matched. In some examples, the events may indicate that different stages of an execution block have been executed. In various examples, the media and events 110 may include several streams of data from various sensors that are synchronized in time. The drones solution edge 104 can receive the raw media and events 110 and generated media and events 112 based on the raw media and events 110. In some examples, the drones solution edge 104 may detect one or more events in the raw media of the raw media and events 110. In some examples, the detected events may be added as metadata in the media and events 112. The drones solution edge 104 may also filter the raw media and events 110 to generate media and events 112. For example, only media and events related to a particular AI model in the drones solution edge 104 may be included in the media and events 112. For example, the media and events 112 may exclude some of the raw media and events 110 that are determined to be unrelated to a particular AI model used to define a mission objective. In various examples, the drones solution edge 104 may thus also include one or more AI models for processing the raw media and events 110. The drones solution edge 104 may then transmit the media and events 112 to the drones solution engine 102. The drones solution engine 102 can receive and transmit the media and events 112 to the AI analytics service 106 for further processing. As one example, the media and events 112 may include images of a target object with rectangles around the target object in the images. In this manner, bandwidth may be saved by not sending all raw media and events 110 from the drones solution edge 104 to the drones solution engine 102. Moreover, this may enable real-time processing to be performed at the drones solution edge 102.

The AI analytics service 106 may be trained to generate smart insights 114 based on the received media and events 112. For example, the AI analytics service 106 may include one or more trained AI models. For example, the AI models may include object detection models, etc., that can be used to identify and locate specific objects or conditions that are included in the generated smart insights 114. In some examples, the AI analytics services 106 may include AI models that are not related to visual recognition and be based on other sensors of the drone. For example, the AI models may be trained to detect temperature, air quality. As one examples, such AI models may use a regressor model to predict a likelihood of fire. In various examples, the AI model used by the AI analytics service 106 may also be changed to a different model in response to the smart insights 114. For example, the different model may be generated by retraining the AI model based on new inputs. The drones solution engine 102 may receive the smart insights 114 from the AI analytics services 106 and generate execution blocks 116 based on the smart insights 114. For example, the execution blocks 116 may each include a particular sequence of commands or set of actions to perform. The execution blocks 116 may include particular routes, and which sensors to activate at which times or locations. In some examples, at least some of the execution blocks may be a predefined sequence of commands. For example, if an area is to be scanned in order to search for a person, a first execution block 116 may be a predefined route that scans the area in some pattern. However, while executing this execution block 116, the system 100 might identify a person. Then, the drones solution engine 102 can generate a new execution block 116 that navigates the deployed drone 108 to a location where the person was detected. In various examples, all execution blocks are dynamically generated. The drones solution engine 102 may then send the generated execution blocks 116 to the drones solution edge 104. The drones solution edge 104 may then generate drone specific commands 118 based on the execution blocks 116. In some examples, the drones solution edge 104 can also use local AI models or services to perform filtering or to adjust execution blocks 116 before generating drone specific commands 118 to be transferred to the drone 108. The drones solution edge 104 can transmit the drone specific commands 118 to the deployed drone 108 as the deployed drone 108 is flying.

The drone specific commands 118 are received by the deployed drone 108. The deployed drone 108 may then execute the drone specific commands 118. For example, the drone specific commands 118 may be used instead of a previous set of specific commands to travel a particular route, select sensors to activate, and when and where to activate the selected sensors. In some examples, the drone specific commands 118 may be received subsequently to a previous set of drone specific commands 118. For example, the deployed drone 108 may request for additional drone specific commands 118 from the drones solution edge 104 and the drone solutions edge 104 may request additional execution blocks 116 from the drones solution engine 102.

In some examples, the drones solution engine 102 may not have an execution block 116 available to send to the drones solution edge 104 when a previous set of drone specific commands 118 associated with a previous execution block have been fully executed by the deployed drone 108. In this case, an idle execution block 116 may be sent by the drones solution engine 102 to the drones solution edge 106 in response to detecting a request for a new execution block before the execution block is generated. The drones solution edge 106 may then generate drone specific commands 118 based on the idle execution block 116. As one example, the idle execution block 116 may be an execution block 116 that is predefined in advance. For example, the idle execution block 116 may indicate to hover in a same position for a predetermined amount of time and request for another execution block. In various examples, the drones solution edge 106 may include a buffer (not shown) to receive a subsequently generated execution block or a predefined execution block before the previously drone specific commands 118 are executed by the deployed drone 108. In some examples, the drones solution edge 106 may send drone specific commands 118 to the deployed drone 108 as the drones solution edge 106 receives execution blocks. In some examples, the drones solution edge 106 may send drone specific commands 118 to the deployed drone 108 in response to receiving a request for additional drone specific commands 118 from the deployed drone 108.

As one example, a deployed drone 108 may be deployed to scan an area. The deployed drone 108 may have imaging sensors, including thermal imaging sensors, among other sensors. The deployed drone 108 may send sensor data in the form of raw media and events 110 to the drones solution edge 104 to eventually be analyzed by the AI analytics services 106. Based on smart insights 114 from the AI analytics services 106, the drones solution engine 102 generates a number of execution blocks 116 and sends the execution blocks to the drones solution edge 104. In some examples, the execution blocks 116 may be a sequence of predefined execution blocks 116 that are sent to the drones solution edge 104 for execution. For example, the execution blocks 116 may be predefined based on the particular scanning task to be performed. The drones solution edge 104 may generate drone specific commands 118 and sends the drone specific commands 118 to the deployed drone 108. The deployed drone 108 may then execute the drone specific commands 118 and send feedback in the form of raw media and events 110 to the drones solution edge 104. For example, the raw media and events 110 may include all sensor data from the particular area being scanned. For example, the sensor data may include captured images and associated location data. For example, the location data may include data from a global navigation satellite system (GNSS), such as Global Positioning System (GPS) sensor data or any other GNSS. In some examples, the location data may be received from an inertial navigation system (INS). For example, the INS may include a computer, motion sensors and rotation sensors to continuously calculate by dead reckoning the position, the orientation, and the velocity of a moving object without the need for external references.

In various examples, new execution blocks 116 may be generated by the drones solution engine 102 based on smart insights 114 from the AI analytics serves 106 with respect to the raw media and events 110 received from the deployed drone 108. In some examples, the predefined sequence of execution blocks 116 may be modified based on the smart insights 114 from the AI analytics serves 106. For example, the AI analytics services 106 may be visual analytics services that analyze images captured by image sensors of the deployed drone 108. The smart insights 114 may thus be based on the analyzed images and other sensor information from the deployed drone 108. In some examples, the events may include a detected object in one or more images captured by the deployed drone 108. As one example, a crack in a wall may be included in the raw media and events 110 and the deployed drone 108 may receive drone specific commands 118 from the drones solution edge 104 to change position and capture additional images of the wall in order to inspect the detected crack in the wall in greater detail in response to detecting the crack via the smart insights 114. In some examples, an additional AI model may be used in response to the raw media and events 110. For example, an additional AI model may be used to revive additional raw media and events to be used to estimate the width of the detected crack. For example, the additional AI model may be located in either the drones solution edge 104 or the AI analytics services 106. In some examples, a sequential execution block 116 may be generated accordingly to estimate the width of the crack.

As another example, the raw media and events 110 may include thermal imaging with a detected thermal object that may be inspected more closely via the drone specific commands 118. For example, the altitude of the deployed drone 108 may be modified, the angles of the thermal imaging sensor may be modified, etc.

In another example, the deployed drone 108 may be deployed using a predefine sequence of execution blocks used to generate drone specific commands 118 to inspect a parking lot of various cars. The deployed drone 108 may detect a particular car to be inspected. In response to detecting the particular car during execution of a first execution block, the deployed drone 108 may receive drone specific commands 118 to change its operation to inspect the license plate or other features of the car in a second execution block. The deployed drone 108 may then execute drone specific commands 118 corresponding to the second execution block and send additional raw media and events 110 to the drones solution engine 102 via the drones solution edge 104. The deployed drone 108 may execute drone specific commands 118 corresponding to a third execution block 116 by flying to a home position and landing. In various examples, the first and third execution block 116 may have been pre-planned.

In another example, a deployed drone 108 may be deployed as a first aid response. The deployed drone 108 may scan an area and detect persons in danger or laying on the ground. The deployed drone 108 may then dynamically return to the exact location of the detected persons to capture a close video feed of the situation. The deployed drone 108 may then return to a home position afterwards. In this example, the execution blocks 116 generated may include a first execution block 116 that includes taking off and scanning an area. For example, this execution block 116 may have been generated in advance. The first execution block 116 may include receiving media and events concerning people in danger and sending them to the drones solution engine 102. A second execution block 116 may include flying to an identified location of a person in danger and sending a live video feed to a remote control center. For example, the second execution block 116 may be dynamically generated based on smart insights 114 on raw media and events 110 received during execution of the first execution block 116. A third execution block 116 in this example may include flying to a home position and landing. The third execution block 116 may also have been pre-planned rather than based on any smart insights 114 on raw media and events 110.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional client devices, or additional resource servers, etc.). For example, some or all of the functionality of the drones solution engine 102 may be implemented in the drones solution edge 104. In various examples, the drones solution edge 104 may include an AI model to provide for reduced latency in precision flights. For example, precision flights may include fine-tuned search of a generally specified area. In some examples, precision flights may be used to scan an area in response to detecting that an object is not at a particular GPS coordinate. Further, in some examples, t=he 106 AI services may also be deployed on the drones solution engine 104 and provide smart insights 114 directly to the drones solution edge 104. For example, to reduce latency, part of the raw data may be analyzed on the drones solution edge 104 and the drone specific 118 commands to the drone 108 adjusted accordingly.

FIG. 2 is a process flow diagram of an example method that can generate execution blocks for dynamically controlling UAVs. The method 200 can be implemented with any suitable computing device, such as the computing device 300 of FIG. 3 and is described with reference to the system 100 of FIG. 1. For example, the method 200 can be implemented by the computing device 300 of FIG. 3.

At block 202, media and events are received from a deployed UAV. For example, the media may be raw media, such as images or other sensor data received from any number of sensors in the UAV. In various examples, the events may include detected objects or detected conditions. For example, the UAV may have an edge device with detection capability onboard. In some examples, the media and events may include time stamps. In various examples, raw media and events from the deployed UAV to are filtered to generate the media and the event.

At block 204, the media and the events are sent to an artificial intelligence (AI) service and smart insights are received from the AI service. In some examples, a different AI model may then be selected based the smart insights. For example, the different AI model may be used to generate smart insights from additional media and events received from the deployed UAV.

At block 206, execution blocks are dynamically generated based on the smart insights. For example, the execution blocks may be generated on-the-fly or in real-time in response to receiving the media and events. In some examples, via the processor, a second execution block may be dynamically generated based on media and events received from the execution of vehicle specific commands of a first execution block.

At block 208, the generated execution block is sent to an edge device for generating vehicle specific commands. In some examples, a predefined execution block and sending the predefined execution block to the edge device. For example, the predefined execution block may be generated in advance of dynamically generating the execution block based on the smart insights. In some examples, the predefined execution block may be an idle block that is generated in advance and sent in response to detecting that a dynamically generated execution block has not been generated.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

In some scenarios, the techniques described herein may be implemented in a cloud computing environment. As discussed in more detail below in reference to at least FIGS. 3-6, a computing device configured to dynamically control UAVs using execution blocks may be implemented in a cloud computing environment. It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

FIG. 3 is block diagram of an example computing device that can generate execution blocks for dynamically controlling UAVs. The computing device 300 may be for example, a server, desktop computer, laptop computer, tablet computer, or smartphone. In some examples, computing device 300 may be a cloud computing node. Computing device 300 may be described in the general context of computer system executable instructions, such as program modules, being executed by a computer system. Generally, program modules may include routines, programs, objects, components, logic, data structures, and so on that perform particular tasks or implement particular abstract data types. Computing device 300 may be practiced in distributed cloud computing environments where tasks are performed by remote processing devices that are linked through a communications network. In a distributed cloud computing environment, program modules may be located in both local and remote computer system storage media including memory storage devices.

The computing device 300 may include a processor 302 that is to execute stored instructions, a memory device 304 to provide temporary memory space for operations of said instructions during operation. The processor can be a single-core processor, multi-core processor, computing cluster, or any number of other configurations. The memory 304 can include random access memory (RAM), read only memory, flash memory, or any other suitable memory systems.

The processor 302 may be connected through a system interconnect 306 (e.g., PCI®, PCI-Express®, etc.) to an input/output (I/O) device interface 308 adapted to connect the computing device 300 to one or more I/O devices 310. The I/O devices 310 may include, for example, a keyboard and a pointing device, wherein the pointing device may include a touchpad or a touchscreen, among others. The I/O devices 310 may be built-in components of the computing device 300, or may be devices that are externally connected to the computing device 300.

The processor 302 may also be linked through the system interconnect 306 to a display interface 312 adapted to connect the computing device 300 to a display device 314. The display device 314 may include a display screen that is a built-in component of the computing device 300. The display device 314 may also include a computer monitor, television, or projector, among others, that is externally connected to the computing device 300. In addition, a network interface controller (NIC) 316 may be adapted to connect the computing device 300 through the system interconnect 306 to the network 318. In some embodiments, the NIC 316 can transmit data using any suitable interface or protocol, such as the internet small computer system interface, among others. The network 318 may be a cellular network, a radio network, a wide area network (WAN), a local area network (LAN), or the Internet, among others. An external computing device 320 may connect to the computing device 300 through the network 318. In some examples, external computing device 320 may be an external webserver 320. In some examples, external computing device 320 may be a cloud computing node.

The processor 302 may also be linked through the system interconnect 306 to a storage device 322 that can include a hard drive, an optical drive, a USB flash drive, an array of drives, or any combinations thereof. In some examples, the storage device may include a receiver module 324, an artificial intelligence (AI) analytics module 326, and an execution block generator module 328. The receiver module 324 can receive media and an event from a deployed UAV. For example, the deployed UAV may be an unmanned aerial vehicle. In some examples, the media received from the deployed UAV includes raw sensor data and the event may be a detected object in the raw sensor data. In some examples, the media and event may be filtered raw media and events. In various examples, the received media and the event are collected using commands associated with a predefined execution block. The AI analytics module 326 can send the media and the event to an artificial intelligence (AI) service and receive smart insights from the AI service. In some examples, the AI analytics module 326 can cause a different AI model to be selected for generating additional smart insights in response to the smart insights. The execution block generator module 328 can dynamically generate an execution block based on the smart insights. The execution block generator module 328 can send the generated execution block to an edge device for generating vehicle specific commands. For example, the execution block is to be used to generate vehicle specific commands to be executed on a deployed UAV.

It is to be understood that the block diagram of FIG. 3 is not intended to indicate that the computing device 300 is to include all of the components shown in FIG. 3. Rather, the computing device 300 can include fewer or additional components not illustrated in FIG. 3 (e.g., additional memory components, embedded controllers, modules, additional network interfaces, etc.). Furthermore, any of the functionalities of the receiver module 324, the AI analytics module 326, and the execution block generator module 328 may be partially, or entirely, implemented in hardware and/or in the processor 302. For example, the functionality may be implemented with an application specific integrated circuit, logic implemented in an embedded controller, or in logic implemented in the processor 302, among others. In some embodiments, the functionalities of the receiver module 324, AI analytics module 326, and execution block generator module 328 can be implemented with logic, wherein the logic, as referred to herein, can include any suitable hardware (e.g., a processor, among others), software (e.g., an application, among others), firmware, or any suitable combination of hardware, software, and firmware.

Referring now to FIG. 4, illustrative cloud computing environment 400 is depicted. As shown, cloud computing environment 400 comprises one or more cloud computing nodes 402 with which local computing devices used by cloud consumers, such as, for example, personal digital assistant (PDA) or cellular telephone 404A, desktop computer 404B, laptop computer 404C, and/or UAV computer system 404N may communicate. Nodes 402 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 404A-N shown in FIG. 4 are intended to be illustrative only and that computing nodes 402 and cloud computing environment 400 can communicate with any type of computerized device over any type of network and/or network addressable connection (e.g., using a web browser).

Referring now to FIG. 5, a set of functional abstraction layers provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided.

Hardware and software layer 500 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 502 provides an abstraction layer from which the following examples of virtual entities may be provided: virtual servers; virtual storage; virtual networks, including virtual private networks; virtual applications and operating systems; and virtual clients. In one example, management layer 504 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 506 provides examples of functionality for which the cloud computing environment may be utilized. Examples of workloads and functions which may be provided from this layer include: mapping and navigation; software development and lifecycle management; virtual classroom education delivery; data analytics processing; transaction processing; and dynamic UAV control.

The present techniques may be a system, a method or computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present techniques may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present techniques.

Aspects of the present techniques are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

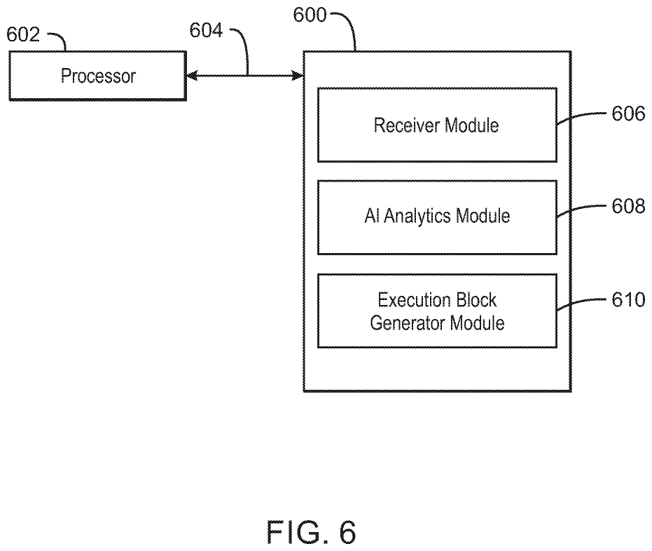

Referring now to FIG. 6, a block diagram is depicted of an example tangible, non-transitory computer-readable medium 600 that can dynamically control UAVs using execution blocks. The tangible, non-transitory, computer-readable medium 600 may be accessed by a processor 602 over a computer interconnect 604. Furthermore, the tangible, non-transitory, computer-readable medium 600 may include code to direct the processor 602 to perform the operations of the method 500 of FIG. 5 above.

The various software components discussed herein may be stored on the tangible, non-transitory, computer-readable medium 600, as indicated in FIG. 6. For example, a receiver module 606 includes code to receive media and an event from a deployed UAV. In some examples, the receiver module 606 includes code to filter raw media and events from the deployed UAV to generate the media and the event. In some examples, the receiver module 606 includes code to receive additional media and events collected by the deployed UAV during execution of commands associated with the execution block. An artificial intelligence (AI) analytics module 608 includes code to send the media and the event to an artificial intelligence (AI) service and receive smart insights from the AI service. In some examples, the AI analytics module 608 further includes code to select a different AI model based the smart insights. An execution block generator module 610 includes code to dynamically generate an execution block based on the smart insights. The execution block generator module 610 also includes code to send the generated execution block to an edge device for generating vehicle specific commands. In various examples, the execution block generator module 610 also includes code to send an idle execution block in response to detecting a request for a new execution block before the execution block is generated. In some examples, the execution block generator module 610 also includes code to dynamically generate a second execution block based on media and events received from the execution of the vehicle specific commands. It is to be understood that any number of additional software components not shown in FIG. 6 may be included within the tangible, non-transitory, computer-readable medium 600, depending on the particular application.

The flowchart and block diagrams in the Figures illustrate the architecture, functionality, and operation of possible implementations of systems, methods, and computer program products according to various embodiments of the present techniques. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 6 may be included within the tangible, non-transitory, computer-readable medium 600, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive media and an event from a deployed unmanned aerial vehicle (UAV);
send the media and the event to an artificial intelligence (AI) service and receive smart insights from the AI service;
dynamically generate an execution block based on the smart insights; and
send the generated execution block to an edge device for generating vehicle specific commands.

2. The system of claim 1, wherein the deployed UAV comprises an unmanned aerial vehicle.

3. The system of claim 1, wherein the media received from the deployed UAV comprises raw sensor data and the event comprises a detected object in the raw sensor data.

4. The system of claim 1, wherein the media and event comprise filtered raw media and events.

5. The system of claim 1, wherein the execution block is to be used to generate vehicle specific commands to be executed on a deployed UAV.

6. The system of claim 1, wherein the received media and the event are collected using commands associated with a predefined execution block.

7. The system of claim 1, wherein the processor is to cause a different AI model to be selected for generating additional smart insights in response to the smart insights.

8. A computer-implemented method, comprising:
receiving, via a processor, media and an event from a deployed unmanned aerial vehicle (UAV);
sending, via the processor, the media and the event to an artificial intelligence (AI) service and receiving smart insights from the AI service;
dynamically generating, via the processor, an execution block based on the smart insights; and
sending, via the processor, the generated execution block to an edge device for generating vehicle specific commands.

9. The computer-implemented method of claim 8, comprising dynamically generating, via the processor, a second execution block based on media and events received from the execution of the vehicle specific commands.

10. The computer-implemented method of claim 8, comprising filtering, via the processor, raw media and events from the deployed UAV to generate the media and the event.

11. The computer-implemented method of claim 8, comprising selecting, via the processor, a different AI model based the smart insights.

12. The computer-implemented method of claim 8, comprising generating, via the processor, a predefined execution block and sending the predefined execution block to the edge device.

13. The computer-implemented method of claim 12, wherein the predefined execution block is generated in advance of dynamically generating the execution block based on the smart insights.

14. The computer-implemented method of claim 8, comprising receiving, via the processor, additional media and events collected by the deployed UAV during execution of commands associated with the execution block.

15. A computer program product for dynamically controlling unmanned aerial vehicles (UAVs), the computer program product comprising a computer-readable storage medium having program code embodied therewith, wherein the computer readable storage medium is not a transitory signal per se, the program code executable by a processor to cause the processor to:
receive media and an event from a deployed UAV;
send the media and the event to an artificial intelligence (AI) service and receive smart insights from the AI service;
dynamically generate an execution block based on the smart insights; and
send the generated execution block to an edge device for generating vehicle specific commands.

16. The computer program product of claim 15, further comprising program code executable by the processor to send an idle execution block in response to detecting a request for a new execution block before the execution block is generated.

17. The computer program product of claim 15, further comprising program code executable by the processor to dynamically generate a second execution block based on media and events received from the execution of the vehicle specific commands.

18. The computer program product of claim 15, further comprising program code executable by the processor to filter raw media and events from the deployed UAV to generate the media and the event.

19. The computer program product of claim 15, further comprising program code executable by the processor to select a different AI model based the smart insights.

20. The computer program product of claim 15, further comprising program code executable by the processor to receive additional media and events collected by the deployed UAV during execution of commands associated with the execution block.
